(19) United States
(12) Patent Application Publication
(10) Pub. No.: US 2016/0019175 A1
(43) Pub. Date: Jan. 21, 2016

(54) METHOD FOR MONITORING COMMUNICATIONS FOR AN ON-CHIP SYSTEM

(71) Applicant: SAGEM DEFENSE SECURITE, Boulogne-Billancourt (FR)

(72) Inventors: Celine Liu, Boulogne-Billancourt (FR); Nicolas Charrier, Boulogne-Billancourt (FR); Nicolas Marti, Boulogne-Billancourt (FR)

(21) Appl. No.: 14/772,060

(22) PCT Filed: Mar. 5, 2014
(86) PCT No.: PCT/EP2014/054279

§ 371 Date: Sep. 1, 2015

(30) Foreign Application Priority Data
Mar. 6, 2013 (FR) 1352014

(51) Int. Cl. G06F 13/364; G06F 11/30; G06F 13/40; G06F 13/42

(52) U.S. Cl. CPC G06F 13/364; G06F 13/4282; G06F 11/3027; G06F 13/4022

(57) ABSTRACT

The invention concerns a method for monitoring transactions in an on-chip system comprising at least one main master module, at least one secondary master module, at least one slave module and a bus connected to each module, the bus comprising interconnection means to make at least one common slave module communicate with at least one main master module and with at least one secondary master module, the method comprising the following steps implemented during each transaction between a secondary master module and a common slave module: starting a counter upon initial detection of a transaction start signal, waiting for a final detection of a transaction end signal within a predefined time T, closing the transaction if the time tc that has elapsed since starting the counter is greater than predefined time Tmax, and reinitialising the counter.

### FIELD OF THE INVENTION

The invention relates to the field of systems on chip often designated by the term system on chip or its abbreviation SoC.

The invention relates more particularly to systems on chip in which the interconnections between modules are made by internal computer buses.

### PRIOR ART

A system on chip (SoC) is a complete system embedded on a chip which can comprise one or more processors, memory, interface peripherals and/or other components necessary for performing a complex function.

SoCs generally have hierarchical architecture: “master” modules execute access reading or writing requests to modules called “slaves”. For example, typical masters are processors or controllers of direct access to memory (DMA); typical slaves are storage memories or network peripherals.

The interconnections between masters and slaves are typically the responsibility of internal computer buses compatible with one or more communication protocols.

For example, the AMBA protocol (“Advanced Microcontroller Bus Architecture”) is a communication standard widely used today especially on SoC multiprocessors. This protocol declines into several versions and variants, including for example AHB (“Advanced High-performance Bus”) and AXI (“Advanced eXtensible Interface”) which are more particularly dedicated to high-rate transfer of data by bursts.

Referring to FIG. 1, a computer bus B ensuring interconnections between k master modules Mi, iε[[1, k]] and n slave modules Sj, jε[[1, n]]. The bus B comprises k slave ports PSi, iε[[1, k]] on each of which is connected a master module, and n master ports PMj, jε[[1, n]], on each of which is connected to a slave module. So, the bus is seen as a slave by each master module, and seen as a master by each slave module. Data can be transmitted according to a specific communication protocol over each link between a port of the bus and a module.

The bus B comprises internal routing means, for example one or more stages of switches shown in FIG. 1 by arrows in dotted lines. These means ensure routing of communications between a master and a slave.

The bus B illustrated in FIG. 1 makes all possible interconnections between one of the k masters and one of the n slaves, or k*n interconnections. In this way, the slave S1 can for example receive requests sent by the several masters, and have access alternately shared between the latter. During concurrent access, the master M1 can be accessing S1, while the master M2 remains on standby. Once access by M1 is terminated, the master M2 can in turn gain access to S1.

However, if a master breaks down while a transaction is underway between this master and a slave, all other masters on access standby to the same slave are kept on standby since the transaction underway is not terminated.

These delays can prove especially annoying in the event where high-priority access must be made very quickly. This the case for example for systems on chip of a level of criticality A according to the RTCA DO-254 standard, on which breakdowns or even transaction slowdowns can have catastrophic consequences, such as for example, systems on chip dedicated to aircraft command control.

The prior art discloses priority management mechanisms aiming to avoid such waits. These management mechanisms however need transmission of additional priority information messages, and an arbitrage step between such priority messages at the level of the interconnection bus.

However, such priority management mechanisms have several disadvantages. On the one hand, some communication protocols (such as the AMBA protocol) by default do not provide the inclusion of priority data in a single request. These priority data are also likely to diminish the bandwidth of the system. Finally, these priority management mechanisms need internal modification to the interconnection bus so that it can execute arbitrage between several concurrent requests.

Also, some systems on chip make a physical distinction, that is, fixed and permanent, between high-priority primary masters and low-priority secondary masters. On such systems on chip, hereinbelow called asymmetrical systems on chip, access requested by a primary master must always be priority relative to the access requested by a slave module, irrespective of their content; consequently, blockage of a transaction underway involving a secondary master module while a primary master is kept on standby can have dramatic consequences.

### PRESENTATION OF THE INVENTION

The aim of the invention is to propose a mechanism limiting, in an asymmetrical system on chip, waits undergone by a primary master module requiring rapid access to a slave module.

For this to happen, the invention relates especially to a transaction-monitoring method in a system on chip comprising at least one primary master module, at least one secondary master module, at least one slave module and a bus connected to each module, the bus comprising interconnection means for having a common slave module communicate with at least one primary master module and with at least one secondary master module, the method comprising the following steps conducted during each transaction between a secondary master module and a common slave module: startup of a counter during initial detection of a transaction start signal, wait for final detection of a signal of transaction completion in a predetermined period, closure of the transaction if the time elapsed from the startup of the counter is greater than the predetermined period, and reset of the counter.

The method described especially detects blockages of transactions between a secondary master module and a slave module interconnected by means of any computer bus AMBA sold commercially or any other bus making interconnections between master and slave modules. The adaptation of a computer bus AMBA for the needs of a system on chip at a level of criticality is therefore not necessary.

Detection of these blockages caused by secondary masters makes possible the release of access to a common slave module for the benefit of a primary master module; the method guarantees access to a slave module for a primary master in a limited and known wait period.

The proposed method can be executed in an asymmetrical system on chip without requiring internal modifications to the master modules or internal modifications to the interconnection bus.

Also, the proposed method avoids transmission of additional management data likely to reduce bandwidth.

The proposed method can also be completed by the following characteristics taken individually or combined when technically possible.

Initial detection and/or final detection can be made over the communication link between the secondary master module and the bus.

The signals which transit over the communication link between the secondary master module and the bus and/or over the communication link between the bus and the slave module can comply with AXI communication protocol.

### DESCRIPTION OF FIGURES

Other characteristics, aims and advantages of the invention will emerge from the following description which is purely illustrative and non-limiting, and which must be viewed with respect to the appended drawings, in which:

FIG. 1 schematically illustrates a known system on chip.

FIG. 2 illustrates a sequence of signals of the AXI protocol sent during reading.

FIG. 3 illustrates a sequence of signals of the AXI protocol sent during writing.

FIG. 4 illustrates a diagram of steps of the monitoring method according to the invention.

FIG. 5 schematically illustrates a system on chip protected by a monitoring device according to the invention.

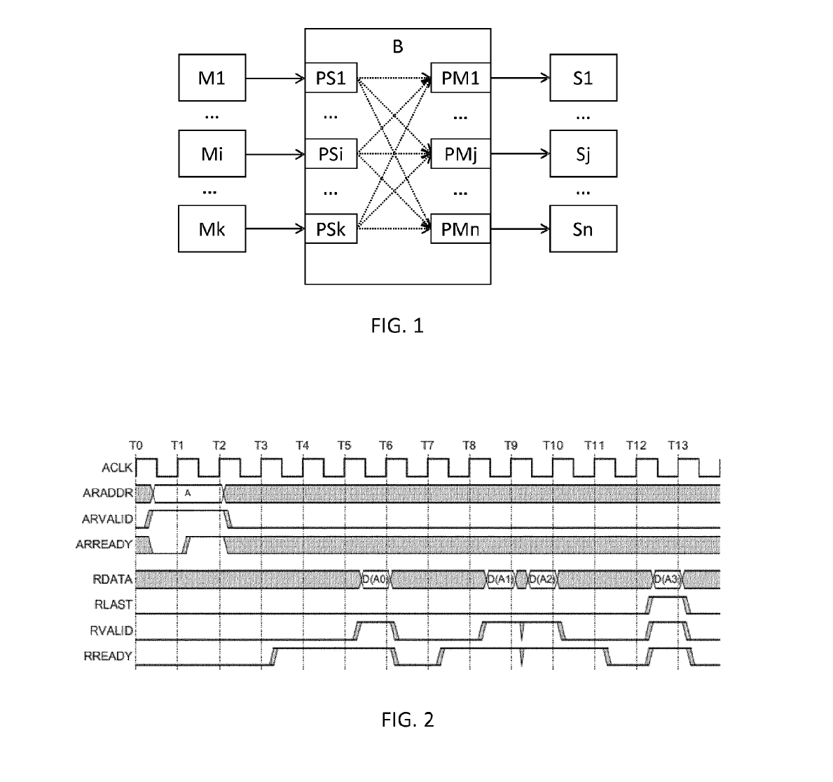

Similar elements bear identical reference numerals in all figures.

### DETAILED DESCRIPTION OF THE INVENTION

The AXI protocol defines a unique interface for describing communications between a master module and a slave module, a master module and the slave port of a bus, or the master port of a bus and a slave module.

This interface comprises five channels:
Two channels dedicated to reading (one control channel and one data channel)
Three to writing (one control channel, one data channel and one response channel).

The channels each transport a set of signals sent by a source and unidirectionally. For example, the reading control channel transports request signals from a master to a slave, while the reading data channel returns data carrier signals from a slave to a master.

The signals must be positioned according to an ordered sequence for executing a read or write data transaction.

Two examples of positioning sequence for reading and writing according to the AXI protocol will now be detailed. All the signals cited in these examples are described in the specification of the AXI protocol.

### Example of Read Transaction

FIG. 2 illustrates for example a positioning sequence of signals for reading by bursts according to AXI protocol, completed in four data transfers. The functions of used signals are listed in the table below:

| Signal | Source | Description |
|---|---|---|
| ACLK | Clock | Reference clock. |
| | source | |
| ARADDR | Master | Read address. |
| ARVALID | Master | Positioned at 1 during transmission by the master |
| | | of a valid read address, if not at 0. |
| ARREADY | Slave | Indicates if the slave is ready (1) or not (0) to |
| | | accept a read address and associated control |
| | | signals. |
| RREADY | Master | Indicates if the master is ready (1) or not (0) to |
| | | receive read data. |
| RDATA | Slave | Read data. |
| RVALID | Slave | Indicates if the expected read data are ready for |
| | | transfer (1) or not (0) |
| RLAST | Slave | Indicates the most recent transfer of read data. |

In reference to FIG. 2, a read transaction according to AXI protocol comprises the following steps.

The signal ACLK is synchronised on the clock of a master. The master sends out the signal ARADDR containing a read address A of the slave to which it wants to give read access. At the same time, the master positions the signal ARVALID at one to signify the validity of the address A to the receiving slave.

The slave confirms the availability of the address A by positioning the signal ARREADY.

The master then positions the signal RREADY at one to signify to the slave that it is ready to read data.

The read data are then transmitted by the slave to the signal RDATA. FIG. 2 illustrates reading of four transfers D(A0), D(A1), D(A2) and D(A3). During each transfer, the signal RVALID is positioned at one by the slave to signify the validity of data to the master. To indicate to the master that a transfer is the last one, the signal RLAST is positioned at one at the start of the final transfer D(A3).

The reading illustrated in FIG. 2 is done in thirteen clock strokes (between the clock strokes T0 and T13).

### Example of Write Transaction

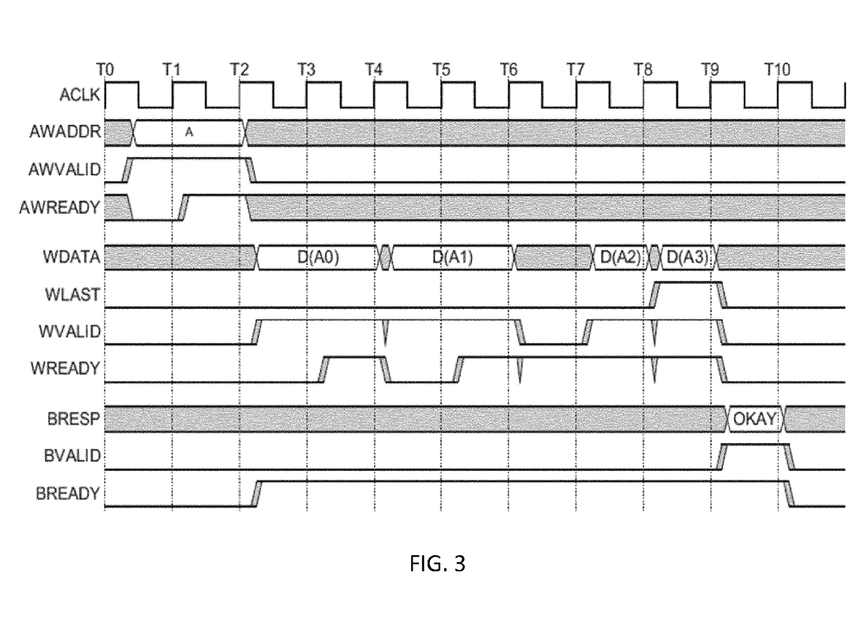

FIG. 3 shows an example of a sequence of positioning signals for writing according to the AXI protocol, and also completed in four data transfers. The functions of these signals are listed in the table below:

| Signal | Source | Description |
|---|---|---|
| ACLK | Clock | Reference clock. |
| | source | |
| AWADDR | Master | Write address. |
| AWVALID | Master | Positioned at 1 during transmission by the master |
| | | of a valid write address, if not at 0. |
| AWREADY | Slave | Indicates if the slave is ready (1) or not (0) to |
| | | accept a write address and associated control |
| | | signals. |
| WREADY | Slave | Indicates if the slave is ready (1) or not (0) to |
| | | receive write data. |
| WDATA | Master | Write data. |
| WVALID | Master | Indicates if the write data are ready for |
| | | transfer (1) or not (0) to the slave. |
| BRESP | Slave | Write result (2 bits): OKAY, EXOKAY, |
| | | SLVERR, or DECERR. |
| BVALID | Slave | Positioned at 1 during transmission by the slave |
| | | of a valid write result, if not at 0. |
| WLAST | Master | Indicates the last transfer of write data. |
| BREADY | Master | Positioned at 1 to signify that the master is ready |
| | | to receive a write result, if not at 0. |

In reference to FIG. 3, a read transaction according to the AXI protocol comprises the following steps.

The signal ACLK is synchronised to a clock source. A master sends the AWADDR signal containing a write address A of the slave to which it wants access. At the same time, the master positions the signal AWVALID at one to signify to the receiving slave the validity of the address A.

The slave confirms the availability of the address A by positioning the AWREADY signal at one.

The slave then positions the WREADY signal at one to signify to the master that it is ready to receive data to be written.

The write data are then transmitted by the master to the WDATA signal. FIG. 3 illustrates a burst of four transfers D(A0), D(A1), D(A2) and D(A3). At the start of the first transfer, the BREADY signal is positioned at one by the master to indicate that it is ready to receive a write result which will be sent on completion of the sequence. During each transfer, the WVALID signal is positioned at one by the master to signify to the slave the validity of data to be written. To indicate to the slave that a transfer D(A3) is the last, the signal WLAST is positioned at one at the start of the last transfer.

To confirm writing to the master, the slave then positions the signal BRESP at the value OKAY. This positioning is accompanied by positioning of the signal BVALID at one throughout transmission of the value OKAY. The master finally repositions the BREADY signal to zero once this value is received.

The writing illustrated in FIG. 3 is done in ten clock strokes (between the clock strokes T0 and T10).

Other signals of the AXI protocol are in practice positioned during reading or writing but they are not detailed in the present document for the sake of simplicity.

Other protocols of the AMBA (AHB, AHB-Lite) family follow the same general principle of write/write transaction with different signals.

Each interface between a bus complying with the AMBA standard and a slave module or master can implement one of the protocols of the AMBA family.

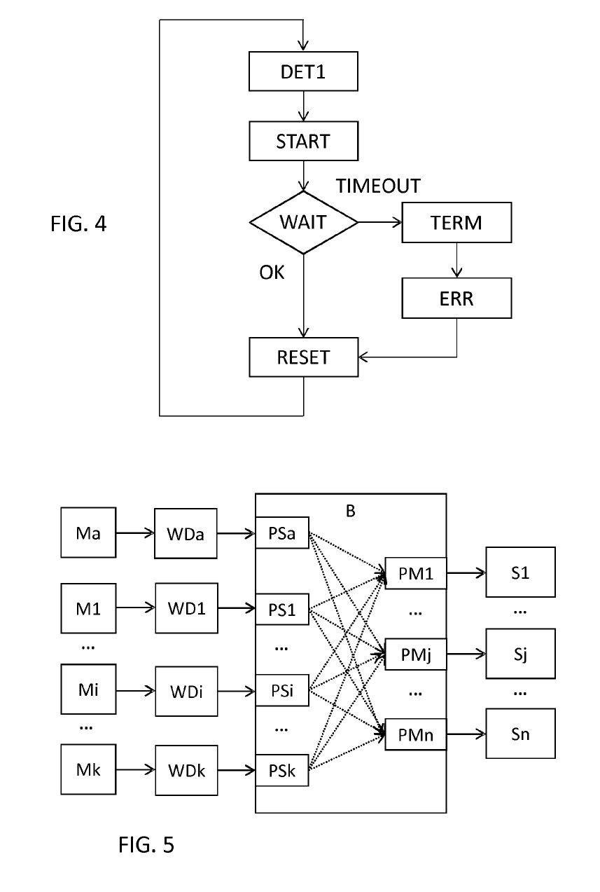

The monitoring method according to the invention will now be described in reference to FIGS. 4 and 5.

In reference to FIG. 5, let this be a system on chip comprising at least one primary master module Ma, at least one secondary master module M1, . . . , Mi, . . . , Mk, at least one slave module S1, . . . , Sj, . . . , Sn and a bus B.

The primary master modules and the secondary master modules are determined by their placement in the system on chip, and are therefore fixed. The bus B comprises interconnection means for communicating at least one common slave module Sj with at least one primary master module Ma and at least one secondary master module M1, . . . , Mi, . . . , Mk.

In the present document, a slave module called “common” will designate a slave module on which several concurrent master modules can access by means of the bus B.

The communication route between a secondary master module Mi and a slave module Sj comprises at least two communication links: a first communication link between the secondary master module Mi and a slave port PSi of the bus B, and a second communication link between a master port PMj of the bus B and the slave module Sj. The signals sent by the secondary master module Mi transit via the slave port PSi, then are routed by the bus B to the master port PMj then are sent to the slave module Sj connected to this master port PMj. The signals sent by the slave module Sj to the secondary master Mi follow the same route in reverse direction.

Similarly, the communication route between a primary master module Ma and the slave module Sj comprises two communication links: a first communication link between the master module Ma and a slave port PSa of the bus B, and a second communication link between the master port PMj of the bus B and the common slave module Sj. The signals sent by the master module Ma transit via the slave port PSa, then are routed via the bus B to the master port PMj then are sent to the slave module Sj connected to this master port PMj. The signals sent by the slave module Sj to the master secondary Mi follow the same route in reverse direction.

The two communications routes between the slave module share Sj and the concurrent master modules Ma and Mi therefore have a common portion of route.

A transaction is underway between a secondary master module Mi and a common slave module Sj.

In reference to the diagram of FIG. 4, a first step “DET” detects on the route between the secondary master module Mi and the slave module Sj a first signal U1 marking the start of a transaction.

When this first signal is detected, a counter is started up “COUNT”. In the present document, the term “startup” means that the counter enters a state in which it increases autonomously, and the value of the counter t_{c} is defined as the accumulated increment from the instant of startup of the counter. The instant of startup is substantially close to the instant of receipt of the first signal U1 such that the value of the counter is substantially proportional to the time elapsed from the instant of detection of this first signal.

In a second step “WAIT”, a second signal U2 marking the end of a transaction is awaited. This wait step WAIT is taken during a predetermined period Tₘₐₓ, and comprises at least one comparison of the value of the counter t_{c} with the period Tₘₐₓ:
if the second signal U2 is detected in the given period (t_{c}<Tₘₐₓ), the duration of the transaction is considered as acceptable (“OK”);
but if the predetermined period expires (“TIMEOUT”) prior to detection of the second signal (t_{c}≧Tₘₐₓ), the duration of the transaction is considered as abnormally long, and a closure step “TERM” of the transaction underway is carried out, releasing access to the slave module Sj for other masters kept on standby.

The counter is then reset “RESET”, that is, on the one hand the incrementing of the counter is stopped and on the other hand the counter is configured for later restart. This reset can for example comprise resetting of the counter, if the value measured by the counter after startup is counted from zero.

On completion of the described method, the primary module Ma can freely access the common slave module Sj and initiate higher-priority transactions.

Also, if the master module involved in the transaction is a primary master module, the described method avoids permanent blockage of the common slave module, this module being by definition priority relative to the secondary master modules.

The AXI protocol can be used on at least one portion of route between the secondary master module Mi and the slave module Sj: for example, over the communication link between the secondary master module Mi and the slave port PSi, over the communication link between the master port PMj and the slave module Sj, or else on these two links. In this way, signals of the AXI protocol can be detected on this portion of route and used as first signal U1 or second signal U2 in the method according to the invention.

The step of initial detection DET of the signal U1 marking the start of the transaction can be made over the communication link between the master module Mi and the slave port PSi of the bus B. This detection placement surely determines the master module Mi at the origin of the transaction underway from the set of secondary master modules M1, . . . , Mk connected to the same bus B.

Final detection of the signal U2 marking the end of the transaction over the communication link between the master module Mi and the slave port PSi can also be made. Since the signal U2 is generally sent via the slave module, this embodiment detects slowness in communication caused by the slave module Sj, if the latter delays in sending the signal U2, but also detects routing problems between the master module and the slave module. For example in this embodiment incorrect or even blocked routing could be detected following malfunction of the bus B.

The counter can be synchronised with a clock used to synchronise communication signals between the master module and the slave module. The counter can be incremented at each clock stroke, and the wait step WAIT can comprise verification of the final detection of the signal of transaction completion for each clock stroke: initial detection and final detection are specified near a clock stroke. The counter can for example be incremented for each rising edge detected on the signal ACLK of a communication link according to the AXI protocol; the period Tₘₐₓ can be seen as a maximal number of clock strokes.

In a variant embodiment, initial detection and final detection are made over the communication link between the secondary master module Mi and the slave port PSi of the bus B, this communication link according to the AXI protocol. In this preferred embodiment, the transaction start U1 and transaction completion U2 signals are signals defined by the AXI protocol for read or write transactions.

If the transaction underway is reading:
the signal U1 can be a rising edge of the signal ARVALID. As has been explained previously, the signal ARVALID is kept at one during transmission of a read address on the signal ARADDR to which the master module wants to access on the slave module.
the signal U2 can as such be a descending edge of the signal RLAST, a signal positioned at one during the final transfer of data of the read transaction.

An absence of descending edge on the signal RLAST after detection of a rising edge on the signal ARVALID in the period Tₘₐₓ detects slowness or a blockage caused by the bus B or the slave module Sj during reading.

Also, if the transaction underway is writing:
the signal U1 can be a rising edge of the signal AWVALID. As also explained, the signal AWVALID is kept to one during transmission of a write address on the signal AWADDR to which the master module wants to access on the slave module.
the signal U2 can as such be a descending edge of the signal WLAST or BVALID:
   a descending edge of the signal WLAST is positioned by the master module during the last transfer of data of the write transaction;
   a descending edge of the signal BVALID is positioned at one while the slave module sends the result of the writing to the signal BRESP.

An absence of descending edge on the signal WLAST after detection of a rising edge on the signal ARVALID in the period Tₘₐₓ detects slowness or a blockage caused by the master Mi during writing, whereas absence of descending edge on the signal BVALID after detection of a rising edge on the signal ARVALID in the period Tₘₐₓ detects slowness or a blockage caused by the bus B or the slave module Sj during writing.

The closure step TERM can comprise injection of a message for the master simulating an erroneous transaction result, for example the value SLVERR in the case of the AXI protocol. In this way, closure of the transaction can be done immediately and coherently such that the master module can later try a transaction of the same type at the same address.

The injection can be made over a communication link according to the AXI protocol by a sequence of positionings in flight of signals for the master module:
If the transaction is reading, the signal RVALID is positioned at one, the signal RRESP is positioned at the value SLVERR during at least one clock stroke, and the signal RVALID is then positioned at 0;
If the transaction is writing, the signal BVALID is positioned at one, the signal BRESP is positioned at the value SLVERR during at least one clock stroke, and the signal BVALID is then positioned at 0.

The method can also comprise an additional sending step “ERR” of an exception message EX to an interruption controller (not shown in the figures) after closure TERM. This step ERR especially notifies of a blockage or slowness problem at the master module Mi initiating the transaction, the target slave module Sj, or else at any other third-party module of the system on chip.

The invention is not limited solely to monitoring of signals defined by the AXI protocol and undertaken in the preferred embodiment described above. In fact, the monitoring method according to the invention can be generalised to any protocol of the AMBA standard or to any combination of protocols of the AMBA family used on a communication route between a master module and a slave module interconnected by at least one bus B.

The invention also relates to a transaction-monitoring device WDi, iε[[1, k]] comprising signal-detection means, storage means, N counters and processing means configured to execute the transaction-monitoring method already described N times in parallel.

The storage means of the device are provided for storage of N periods, for example one or more flash memories or EEPROM. The stored periods can be written once before commissioning of the system on chip, or be reconfigured dynamically; a period is read at least once during execution of the monitoring method according to the invention.

The monitoring device WDi, iε[[1, k]] can optionally be integrated into a bus, form part of a master module, or be in the form of an autonomous module placed on the link between a secondary master module and a slave port of a bus as illustrated in FIG. 5.

A WDa monitoring device can be placed on a link between the bus and a primary master module.

In this way, the number of devices used is adapted to the number of slave ports of the bus B used in the circuit; the non-requested slave ports do not actually need to be monitored.

In a variant, the monitoring device monitors transactions over a communication link on which signals transit according to the AXI protocol. It was shown previously that two signals of the AXI protocol marking the end of transaction in writing can be detected: WLAST or BVALID. Also, two parallel executions of the monitoring method described can provide for the same write transaction, each one requesting a specific counter of the monitoring device and waiting for a specific signal for end of writing (WLAST or BVALID). This simultaneous execution detects a malfunction of a master module, a communication bus and/or a slave module in the same writing.

In reference to FIG. 5, the invention also relates to an assembly comprising at least one primary master module Ma, at least one secondary master module Mi, iε[[1, k]], at least one slave module Sj, jε[[1, n]] and a bus B connected to each module via a communication link, and at least one monitoring device WDi, iε[[1, k]] such as described previously.

The bus B comprises interconnection means for having a common slave module Sj communicate with at least one primary master module Ma and with at least one secondary master module Mi. The bus B illustrated in FIG. 5 for example makes all possible interconnections between master modules and slave modules, since all slave modules are common modules shared between several master modules.

Each transaction-monitoring device WDi, iε[[1, k]] is placed over a communication link between a secondary master module Mi, iε[[1, k]] and the bus B. The assembly can therefore comprise as many monitoring devices as secondary master modules, as illustrated in FIG. 5. Such an assembly monitors the duration of all transactions requested by all the secondary master modules of the system.

Similarly, a WDa monitoring device can be placed on each link between a primary master module Ma and the bus B.

The invention finally relates to a system on chip comprising at least one assembly such as described previously.

1. A transaction-monitoring method in a system on chip comprising at least one primary master module (Ma), at least one secondary master module (M1, . . . , Mi, . . . , Mk), at least one slave module (S1, . . . , Sj, . . . , Sn) and a bus (B) connected to each module by a communication link, the bus (B) comprising interconnection means for having a common slave module (Sj) communicate with at least one primary master module (Ma) and with at least one secondary master module (M1, . . . , Mi, . . . , Mk), lower priority than the primary master module to access the common slave module, the method comprising the following steps conducted during each transaction between a selectively secondary master module (Mi) and a common slave module (Sj):
startup (COUNT) of a counter during initial detection (DET1) of a transaction start signal (U1),
wait (WAIT) for final detection (DET2) of a signal (U2) of transaction completion in a predetermined period Tₘₐₓ,
closure (TERM) of the transaction if the time elapsed t_{c} from the startup of the counter is greater than the predetermined period Tₘₐₓ,
reset (RESET) of the counter.

2. The method according to claim 1, wherein initial detection (DET1) is made over the communication link between the secondary master module (Mi) and the bus (B).

3. The method according to claim 1, wherein final detection (DET2) is made over the communication link between the secondary master module (Mi) and the bus (B).

4. The method according to claim 1, wherein the signals transiting over the communication link between the secondary master module (Mi) and the bus (B) and/or over the communication link between the bus (B) and the slave module (Sj) are compliant with AXI communication protocol.

5. The method according to claim 4, wherein the wait step (WAIT) comprises verification of final detection (DET2) of the signal of transaction completion for each incrementing of the counter, said counter being incremented at each detection over a communication link according to the AXI protocol of a rising edge of the signal ACLK.

6. The method according to claim 4, initial detection (DET1) is made over a communication link according to the AXI protocol, the transaction is reading, and the transaction start signal (U1) is a rising edge of the signal ARVALID.

7. The method according to claim 4, wherein the final detection (DET2) is made over a communication link according to the AXI protocol, the transaction is reading, and the transaction completion signal (U2) is a descending edge of the signal RLAST.

8. The method according to claim 4, wherein initial detection (DET1) is made over a communication link according to the AXI protocol, the transaction is writing, and the transaction start signal (U1) is a rising edge of the signal AWVALID.

9. The method according to claim 4, wherein final detection (DET2) is made over a communication link according to the AXI protocol, the transaction is writing, and the transaction completion signal (U2) is a descending edge of the signal BVALID.

10. The method according to claim 4, wherein final detection (DET2) is made over a communication link according to the AXI protocol, the transaction is writing, and the transaction completion signal (U2) is a descending edge of the signal WLAST.

11. The method according to claim 4, wherein the closure step (TERM) comprises an injection over a communication link according to the AXI protocol of the value SLVERR to the master module.

12. A transaction-monitoring device (WD1, . . . , WDi, . . . , WDk) comprising signal-detection means, storage means, N counters and processing means configured to execute the transaction-monitoring method N times in parallel according to claim 1.

13. A system on chip comprising at least one primary master module (Ma), at least one secondary master (M1, . . . , Mi, . . . , Mk), at least one slave module (S1, . . . , Sj, . . . , Sn) and a bus (B) connected to each module via a communication link, the bus (B) comprising interconnection means for having a common slave module (Sj) communicate with at least one primary master module (Ma) and with at least one secondary master module (M1, . . . , Mi, . . . , Mk), and at least one transaction-monitoring device (WD1, . . . , WDi, . . . , WDk) according to claim 12, each monitoring device being placed over a communication link between a secondary master module (M1, . . . , Mi, . . . , Mk) and the bus (B).
